(19) United States
(12) Patent Application Publication
(10) Pub. No.: US 2014/0307032 A1
(43) Pub. Date: Oct. 16, 2014

(54) MEMBRANE MEMS ACTUATOR INCLUDING FLUIDIC IMPEDANCE STRUCTURE

(71) Applicants: Yonglin Xie, Pittsford, NY (US); James A. Katerberg, Kettering, OH (US)

(72) Inventors: Yonglin Xie, Pittsford, NY (US); James A. Katerberg, Kettering, OH (US)

(21) Appl. No.: 13/859,804

(22) Filed: Apr. 10, 2013

(51) Int. Cl. B41J 2/04

(52) U.S. Cl. CPC B05B 7/0408
USPC 347/54

(57) ABSTRACT

A liquid dispenser includes a first liquid chamber including a nozzle and a second liquid chamber. A flexible membrane is positioned to separate and fluidically seal the first liquid chamber and the second liquid chamber. A heater is associated with the second liquid chamber. A liquid supply channel is in fluid communication with the second chamber. A liquid return channel is in fluid communication with the second chamber. A liquid supply provides a liquid that flows continuously from the liquid supply through the liquid supply channel through the second liquid chamber through the liquid return channel and back to the liquid supply. A fluidic impedance structure is positioned in the second liquid chamber between the heater and the liquid return channel.

### FIELD OF THE INVENTION

This invention relates generally to the field of digitally controlled liquid dispensing devices and, in particular, to liquid dispensing devices that include a flexible membrane.

### BACKGROUND OF THE INVENTION

Ink jet printing has become recognized as a prominent contender in the digitally controlled, electronic printing arena because of its non-impact, low-noise characteristics, its use of plain paper, and its avoidance of toner transfer and fixing. Ink jet printing mechanisms can be categorized by technology as either drop on demand ink jet (DOD) or continuous ink jet (CIJ).

Continuous inkjet printing uses a pressurized liquid source that produces a stream of drops some of which are selected to contact a print media (often referred to a “print drops”) while other are selected to be collected and either recycled or discarded (often referred to as “non-print drops”). For example, when no print is desired, the drops are deflected into a capturing mechanism (commonly referred to as a catcher, interceptor, or gutter) and either recycled or discarded. When printing is desired, the drops are not deflected and allowed to strike a print media. Alternatively, deflected drops can be allowed to strike the print media, while non-deflected drops are collected in the capturing mechanism.

Drop on demand printing only provides drops (often referred to a “print drops”) for impact upon a print media. Selective activation of an actuator causes the formation and ejection of a drop that strikes the print media. The formation of printed images is achieved by controlling the individual formation of drops. Typically, one of two types of actuators is used in drop on demand printing devices—heat actuators and piezoelectric actuators. When a piezoelectric actuator is used, an electric field is applied to a piezoelectric material possessing properties causing a wall of a liquid chamber adjacent to a nozzle to be displaced, thereby producing a pumping action that causes an ink droplet to be expelled. When a heat actuator is used, a heater, placed at a convenient location adjacent to the nozzle, heats the ink. Typically, this causes a quantity of ink to phase change into a gaseous steam bubble that displaces the ink in the ink chamber sufficiently for an ink droplet to be expelled through a nozzle of the ink chamber.

In some applications it may be desirable to use an ink that is not aqueous and, as such, does not easily form a vapor bubble under the action of the heater. Heating some inks may cause deterioration of the ink properties, which can cause reliability and quality issues. As described in U.S. Pat. No. 4,480,259 and U.S. Pat. No. 6,705,716, one solution is to have two fluids in the print head with one fluid dedicated to respond to an actuator, for example, to create a vapor bubble upon heating, while the other fluid is the ink. The performance capabilities of these types of print heads is often limited due to the resistance of the membrane or diaphragm that separates the actuator fluid from the ink which reduces the amount of volumetric displacement that occurs in ink chamber as a result of the pressure caused by the vaporization of the actuator fluid. Diaphragm performance notwithstanding, there is a desire to actuate the print head rapidly so as to increase print speeds. Even though it already may be possible to exceed traditional DOD ink jet print head performance using the print heads described above, performance inefficiencies, typically, associated with pressure loss that occurs during vapor bubble formation which may cause fluid to be displaced into one or both of an inlet or outlet channel in the print head.

As such, there is an ongoing effort to improve the reliability and performance of print heads that include two fluids and a flexible membrane.

### SUMMARY OF THE INVENTION

According to an aspect of the present invention, a liquid dispenser includes a first liquid chamber including a nozzle and a second liquid chamber. A flexible membrane is positioned to separate and fluidically seal the first liquid chamber and the second liquid chamber. A heater is associated with the second liquid chamber. A liquid supply channel is in fluid communication with the second chamber. A liquid return channel is in fluid communication with the second chamber. A liquid supply provides a liquid that flows continuously from the liquid supply through the liquid supply channel through the second liquid chamber through the liquid return channel and back to the liquid supply. A fluidic impedance structure is positioned in the second liquid chamber between the heater and the liquid return channel.

### BRIEF DESCRIPTION OF THE DRAWINGS

In the detailed description of the example embodiments of the invention presented below, reference is made to the accompanying drawings, in which:

FIG. 1 shows a Lumped parameter fluid impedance (inertance) model;

FIG. 2 is a schematic cross sectional view of an example embodiment of a liquid dispenser made in accordance with the present invention;

FIG. 3 is a schematic cross sectional view of another example embodiment of a liquid dispenser made in accordance with the present invention;

FIG. 4 is a schematic cross sectional view of the example embodiments shown in FIG. 2 or 3 in an actuated state;

FIGS. 5A and 5B are a cross sectional view and a plan view, respectively, showing an example embodiment of a fluidic impedance structure included in a liquid dispenser made in accordance with the present invention;

FIGS. 6A and 6B are a cross sectional view and a plan view, respectively, showing another example embodiment of a fluidic impedance structure included in a liquid dispenser made in accordance with the present invention;

FIGS. 7A and 7B are a cross sectional view and a plan view, respectively, showing another example embodiment of a fluidic impedance structure included in a liquid dispenser made in accordance with the present invention;

FIGS. 8A and 8B are a cross sectional view and a plan view, respectively, showing another example embodiment of a fluidic impedance structure included in a liquid dispenser made in accordance with the present invention;

FIGS. 9A and 9B are a cross sectional view and a plan view, respectively, showing another example embodiment of a fluidic impedance structure included in a liquid dispenser made in accordance with the present invention;

FIG. 10 is a schematic top view of an example embodiment of a heater included in a liquid dispenser made in accordance with the present invention; and

FIG. 11 is a plan view of another example embodiment of a fluidic impedance structure that can be included in a liquid dispenser made in accordance with the present invention.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art. In the following description and drawings, identical reference numerals have been used, where possible, to designate identical elements.

The example embodiments of the present invention are illustrated schematically and not to scale for the sake of clarity. One of the ordinary skills in the art will be able to readily determine the specific size and interconnections of the elements of the example embodiments of the present invention.

As described herein, the example embodiments of the present invention provide liquid ejection components typically used in inkjet printing systems. However, many other applications are emerging which use inkjet printheads to emit liquids (other than inks) that need to be finely metered and deposited with high spatial precision. As such, as described herein, the terms “liquid” and “ink” refer to any material that can be ejected by the liquid ejection system or the liquid ejection system components described below.

In addition to inkjet printing applications in which the fluid typically includes a colorant for printing an image, a fluid ejector or liquid dispenser including a membrane MEMS actuator as described below can also be advantageously used in ejecting other types of fluidic materials. Such materials include functional materials for fabricating devices (including conductors, resistors, insulators, magnetic materials, and the like), structural materials for forming three-dimensional structures, biological materials, and various chemicals. The liquid dispenser described herein can provide sufficient force to eject fluids having a higher viscosity than typical inkjet inks, and does not impart excessive heat into the fluids that could damage them or change their properties undesirably.

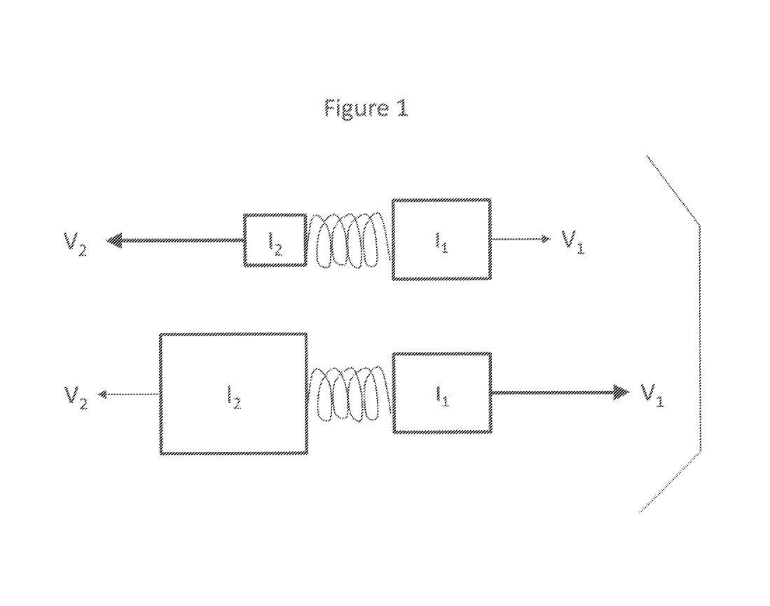

Referring to FIG. 1, a lumped fluid model can be used to understand the factors that affect the efficiency of vapor bubble actuation in the working fluid chamber of the liquid ejector or dispenser of the present invention. The vapor bubble is an energy source similar to a “compressed spring.” The load of the “compressed spring” includes two components. The inertance I₁ of flexible membrane and the fluid on the other side of the flexible membrane in the ink chamber forms the first load. It's desirable to maximize the velocity V₁ and displacement of this load. The inertance I₂ of inlet and outlet channels of the working fluid chamber forms the second load. It's desirable to minimize the velocity V₂ and displacement of this load so that maximum amount of the energy in the “compressed spring” will be transferred to the first load.

In a lumped fluid model, the intertance I of a fluid channel with no restrictions can be calculated using the following equation:

I=ρL/A

Where ρ is the density of the fluid, L is the length of the fluid channel, and A is the cross sectional area of the fluid channel. Therefore, reducing the cross sectional area or increasing the fluid channel length result in increase of the inertance I of a fluid channel.

The pressure gradient is related to the change in flow-rate by the equation:

$$Δ p - I \cdot \dot{Q} - I \cdot \frac{d Q}{d t}$$

Thus, the ratio Δp/flow rate increases with increasing intertance. As a consequence, the flow restriction structure(s) of the present invention cause a sudden pressure build up to be contained in the region of drop formation and has the additional beneficial result that they prevent the sudden increase in the flow of the working fluid when the print head is actuated.

Flow restriction structures have been used at the inlet of DOD inkjet drop ejectors to increase the drop ejection efficiency. However, these flow restriction structures also increase the flow resistance of the capillary ink refill flow after each drop ejection cycle which reduces the drop ejection frequency. Therefore, careful trade-offs have to be made between the drop ejection efficiency and drop ejection frequency. In the present invention, the increase in the flow resistance of replenish fluid flow through the fluid inlet channel to the working fluid chamber can be compensated by increasing the fluid supply pressure to maintain the vapor bubble actuation frequency in the working fluid chamber. Therefore, actuation efficiency can be improved in the present invention without sacrificing the actuation frequency.

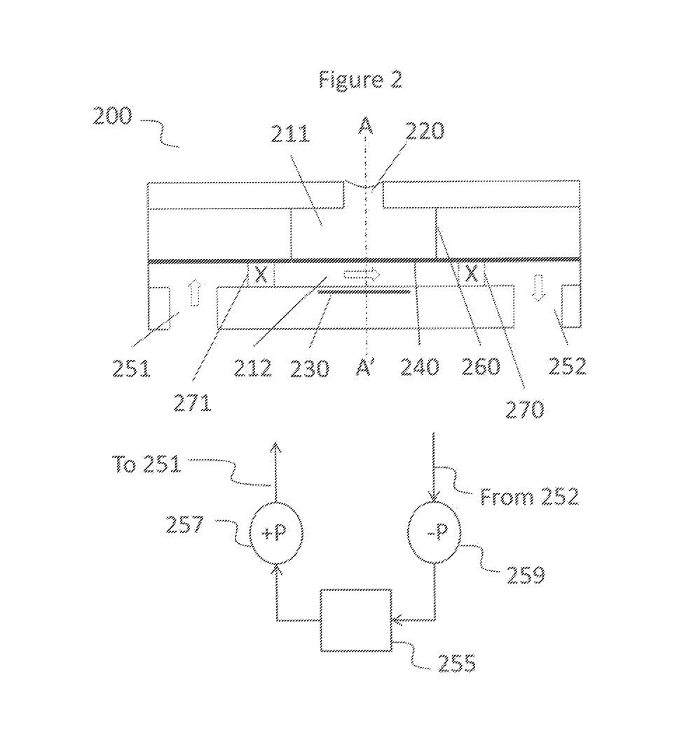

Referring to FIGS. 2-4, a liquid dispenser 200 including a membrane MEMS actuator is shown. Liquid dispenser 200 includes a first liquid chamber 211 and a second liquid chamber 212. First liquid chamber 211 is in fluid communication with a nozzle 220. A flexible membrane 240, 241 is positioned to separate and fluidically seal the first liquid chamber 211 and the second liquid chamber 212 from each other.

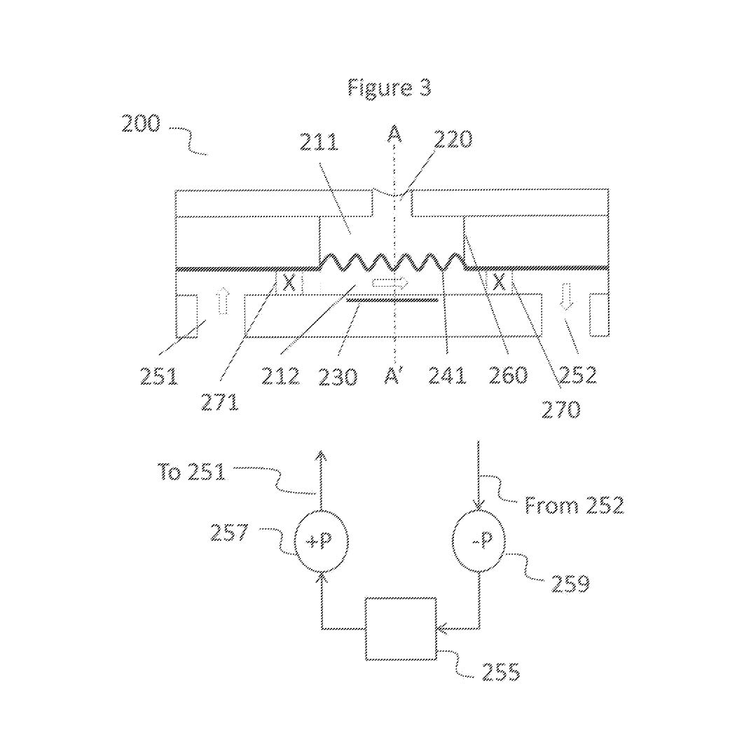

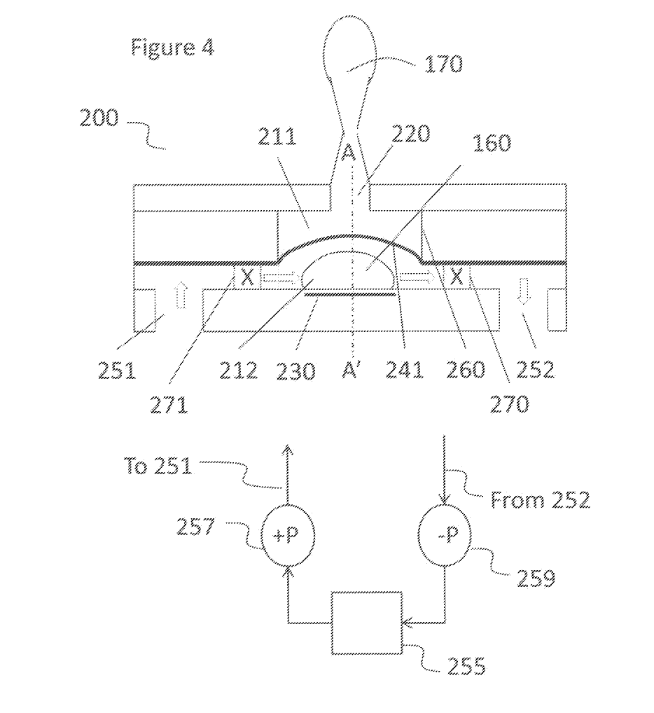

A thermal actuator 230 is associated with a second liquid chamber 212. As shown in FIGS. 2 and 3, thermal actuator 230 is located in a wall of second liquid chamber 212 opposite flexible membrane 240, 241. Thermal actuator 230 is selectively actuated and uses heat energy to divert a portion of a liquid (often referred to as a first liquid) located in first liquid chamber 211 through nozzle 220. The thermal actuator shown in FIGS. 2-4, is a heater, commonly referred to as a “bubble jet” heater, that, when actuated, vaporizes a portion of a liquid (often referred to as a second liquid) in second liquid chamber 212 in the vicinity of the heater creating a vapor bubble 160 (shown in FIG. 4) which causes the first liquid to the ejected through nozzle 220. Heater 230 is located in a wall of the second liquid chamber 212 opposite flexible membrane 240, 241. A center axis A-A′ extends through the center of nozzle 220. Nozzle 220 includes a center point, heater 230 includes a center point, and flexible membrane 240, 241 includes a center point.

As shown in FIG. 2, liquid dispenser 200 includes a flexible membrane 240 that includes no corrugation when flexible membrane 240 is in an unactuated or at rest position. In this sense, flexible membrane is flat when viewed in cross section, as shown in FIG. 2. The overall shape of flexible membrane 240 is planar when viewed from end to end of flexible membrane 240; and flexible membrane 240 is not pre-stressed in one direction, for example, either toward or away from nozzle 220. The overall shape of flexible membrane 240 is symmetric relative to center axis A-A′ when viewed in cross section, as shown in FIG. 2, from end to end of flexible membrane 240. Center points of nozzle 220, heater 230, and flexible membrane 240 are collinear relative to each other and are located along center axis A-A′ that extends through the center of nozzle 220.

In FIG. 3, flexible membrane 241 is corrugated when in an unactuated or at rest position when viewed in cross section, as shown in FIG. 3. The overall shape of flexible membrane 241 is planar when viewed from end to end of flexible membrane 241; and flexible membrane 241 is not pre-stressed in one direction, for example, either toward or away from nozzle 220. The overall shape of flexible membrane 241 is symmetric relative to center axis A-A′ when viewed in cross section, as shown in FIG. 3, from end to end of flexible membrane 241. A center point of nozzle 220, heater 230, and flexible membrane 241 are collinear relative to each other and located along center axis A-A′ that extends through the center of nozzle 220.

In FIG. 4, a portion of the flowing second liquid located in second liquid chamber 212 is vaporized, forming a vapor bubble 160, when electric energy is applied to heater 230. The pressure resulting from the expanding vapor bubble 160 pushes flexible membrane 240, 241 toward nozzle 220 (up as shown in the figure) and causes flexible membrane 240, 241 to bend (and straighten with respect to membrane 241) in an arcuate manner. This is often referred to as an actuated position or state of flexible membrane 240, 241. The displacement of the flexible membrane 240 or flexible corrugated membrane 241 pressurizes the first liquid located in first liquid chamber 211 causing a liquid drop 170 to be ejected through nozzle 220.

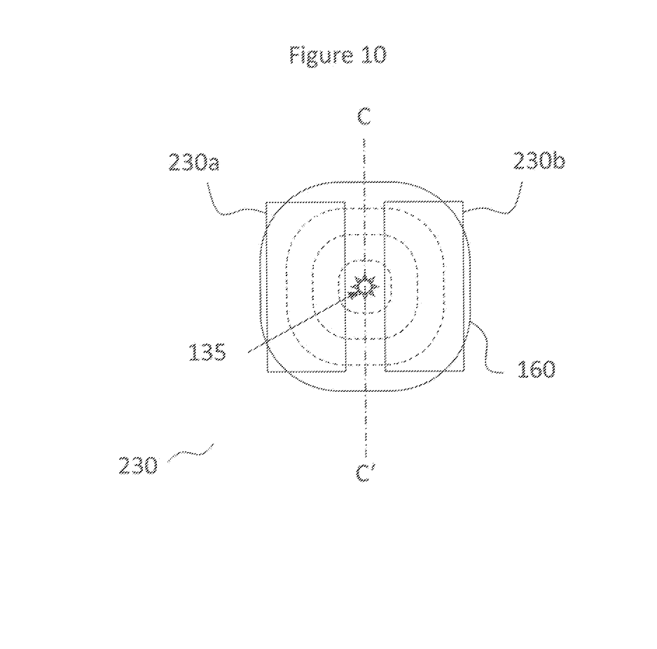

Referring now to FIG. 10, heater 230 can be configured as a split heater as viewed along the direction of the center axis A-A′. The two halves 230a and 230b of the split heater 230 are symmetric relative to a plane C-C′ that includes the center point 135 of the heater 230. A vapor bubble 160 is depicted in FIG. 10 using concentric rings. The split heater configuration allows the vapor bubble 160 to collapse at the center point 135 of the heater 230 which helps to reduce or even avoid cavitation damage to the heater.

Referring back to FIGS. 2-4, a liquid supply channel 251 is in fluid communication with second chamber 212 and a liquid return channel 252 is in fluid communication with second chamber 212. Liquid supply channel 251 and liquid return channel 252 are also in fluid communication with a liquid supply 255. During a drop ejection or dispensing operation, liquid supply 255 provides a pressurized liquid (commonly referred to as a working fluid or a working liquid) that flows continuously from liquid supply 255 through liquid supply channel 251 through second liquid chamber 212 through liquid return channel 252 and back to liquid supply 255. The circulating working fluid helps to increase the drop ejection frequency by removing at least some of the heat generated by heater 230 when it is actuated during drop ejection. The circulating working fluid also can help increase the drop ejection frequency by pushing at least some of vapor bubble 160 off of and away from the heater 230 area as vapor bubble 160 collapses or increasing the speed of liquid replenishment relative to heater 230. As shown in the figures, the liquid moves over heater 230.

Typically, a regulated pressure source 257 is positioned in fluid communication between liquid supply 255 and liquid supply channel 251. Regulated pressure source 257, for example, a pump, provides a positive pressure that is usually above atmospheric pressure. Optionally, a regulated vacuum supply 259, for example, a pump, can be included in order to better control liquid flow through second chamber 212. Typically, regulated vacuum supply 259 is positioned in fluid communication between liquid return channel 252 and liquid supply 255 and provides a vacuum (negative) pressure that is below atmospheric pressure. Liquid supply 255, regulated pressure source 257, and optional regulated vacuum supply 259 can be referred to as the liquid delivery system of liquid dispenser 200.

In one example embodiment, liquid supply 255 applies a positive pressure provided by a positive pressure source 257 at the entrance of liquid supply channel 251 and a negative pressure (or vacuum) provided by a negative pressure source 259 at the exit of liquid return channel 252. This helps to maintain the pressure inside second liquid chamber 212 at substantially the same pressure (for example, ambient pressure conditions) at the exit of nozzle 220 when the heater 230 is not energized. As a result, flexible membrane 240, 241 is not deflected during a time period of drop dispensing when the heater 230 is not energized.

A high degree of flexibility in flexible membrane 240, 241 is preferred to effectively transmit the pressure generated by vapor bubble 160 in the working fluid (a second liquid) to the fluid or liquid of interest (a first liquid), for example, ink, located in first chamber 211. In FIG. 3, this aspect of the invention is enhanced by incorporating a corrugated shape in a high modulus material membrane. The corrugated membrane can be made out of high modulus materials such as alloys, metals, or dielectric materials, to meet fabrication requirements of mechanic strength, durability, or thinness of the flexible membrane. These types of relatively strong materials may not have a high degree of elasticity, but the effect of the corrugation helps to greatly increase the membrane flexibility without requiring the use of an elastic material when compared to non-corrugated membranes. In FIG. 2, since flexible membrane 240 is not corrugated, an elastic material can be included with or substituted for a high modulus material during flexible membrane fabrication to help transmit the pressure generated by vapor bubble 160.

As flexible membrane 240, 241 fluidically seals first chamber 211 and second chamber 212 from each other, first chamber 211 and second chamber 212 are physically distinct from each other which allows the first liquid and the second liquid present in each respective chamber to be different types of liquid when compared to each other in example embodiments of the invention. For example, the second liquid can include properties that increase its ability to remove heat while the first liquid can be an ink. The second liquid can include properties that lower its boiling point when compared to the first liquid. The second liquid can include properties that make it a non-corrosive liquid, for example, nonionic liquid, in order to improve and maintain the functionality of heater 230 or increase its lifetime.

Typically, liquid is supplied to first chamber 211 in a manner similar to liquid chamber refill in a conventional drop on demand device. For example, during a drop dispensing operation using liquid dispenser 200, the liquid is not continuously flowing to first chamber 211 during a drop ejection or dispensing operation. Instead, first chamber 211 is refilled with liquid on an as needed basis that is made necessary by the ejection of a drop of the liquid from first chamber 211 through nozzle 220.

Liquid dispenser 200 also includes a fluidic impedance structure 270 positioned in second liquid chamber 212 between heater 230 and liquid return channel 252. Optionally, a second fluidic impedance structure 271 can be positioned in second liquid chamber 212 between heater 230 and liquid supply channel 251. As the liquid pressure in liquid supply channel 251 upstream of fluidic impedance structure 270 is higher than the liquid pressure in liquid return channel 251 downstream of fluidic impedance structure 271, in one example embodiment of the invention, the flow impedance of fluidic impedance structure 270 is lower than the flow impedance of the second fluidic impedance structure 271. Example components that can be included in the fluidic impedance structure of the present invention in order to accomplish flow restriction control include pillars, screens, walls, check valves, or fluid diodes. These components are generally located at either the inlet, the outlet, or both the inlet and outlet of the second liquid chamber to increase at least one of actuation pressure or refill speed.

Fluidic impedance structure 270 and optional fluidic impedance structure 271 increase the vapor bubble pressure impulse on flexible membrane 240, 241 by reducing liquid flow from second liquid chamber 212 to liquid supply channel 251 and liquid return channel 252. As a result, the force of vapor bubble 160 is concentrated on, or in the vicinity of, flexible membrane 240, 241 resulting in a faster and larger drop 170 ejection through nozzle 220. The circulating working fluid helps to increase the speed at which liquid replenished in second liquid chamber 212, and over heater 230, which also helps to increase the drop ejection frequency, by moving or pushing vapor bubble 160 off or away from the heater area during vapor bubble collapsing and increase the speed of liquid replenishing over the heater.

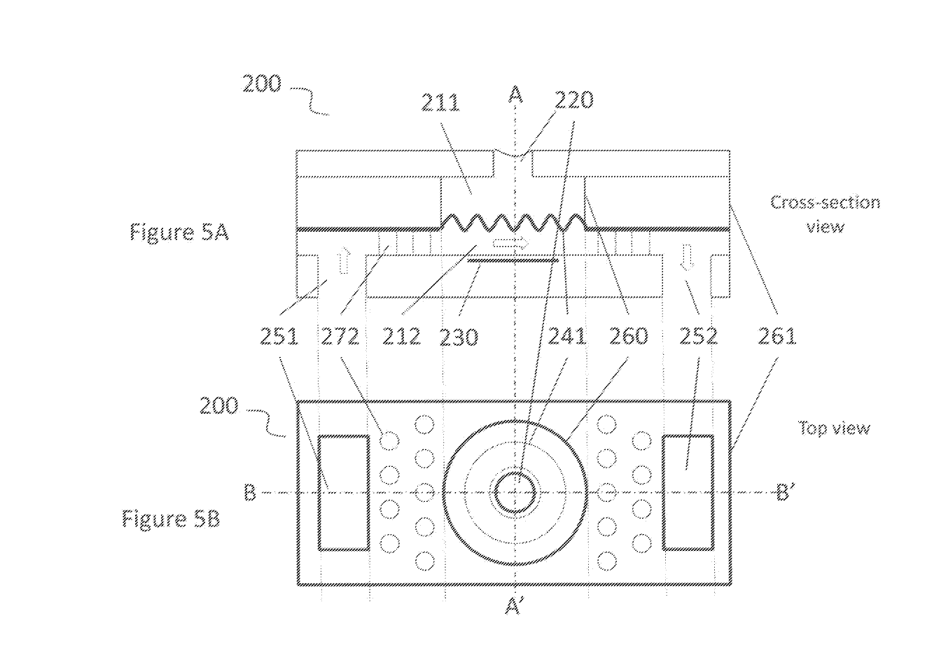

Referring to FIGS. 5A and 5B, a cross sectional view of liquid dispenser 200 and a plan view of flexible membrane 241 and second liquid chamber 212 are shown. The cross sectional view in FIG. 5A of liquid dispenser 200 is taken along line B-B′ shown in FIG. 5B that includes the center axis A-A′. The plan view in FIG. 5B includes the portion of flexible membrane 241 that separates and fluidically seals first liquid chamber 211 and second chamber 212, and second liquid chamber 212. Flexible membrane 241 is circular in shape. First liquid chamber 211 is circular in shape. The fluidic impedance structure 270 of the liquid dispenser 200 includes a plurality of circular posts 272. In the plan view of FIG. 5B, the wall of the first liquid chamber 211 is indicated by the outline 260 and the wall of the second liquid chamber 212 is indicated by the outline 261. Second liquid chamber 212 is larger than first liquid chamber 211 as viewed along the direction of liquid flow through second chamber 212 (indicated using the arrow shown in FIG. 5A). Posts 272 are positioned in an area of second liquid chamber 212 that is outside of the area of first liquid chamber 211 and the region in which flexible membrane 241 separates first liquid chamber 211 and second liquid chamber 212. As shown in FIG. 5B, posts 272 are arranged in a two dimensional pattern with a first row of posts being offset relative to a second row of posts 272. This creates somewhat of a tortured path for the fluid through the posts 272. The first row of posts 272, closest to heater 230 (or flexible membrane 240, 241) has a greater number of posts 272 when compared to the second row which is closer to the interface of second chamber 212 and liquid return channel 252. The first row of posts 272 across second liquid chamber 212 in a direction perpendicular to fluid flow more so than the second row of posts 272. The number and location relative to each other of posts 272 typically depends on the application contemplated and are sufficient to improve actuation efficiency without unnecessarily sacrificing actuation frequency.

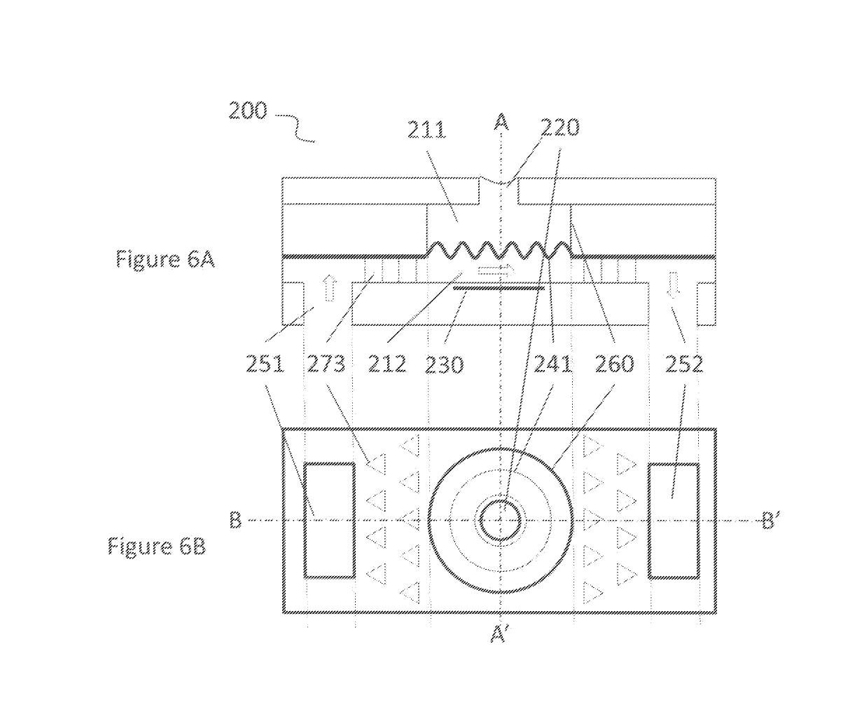

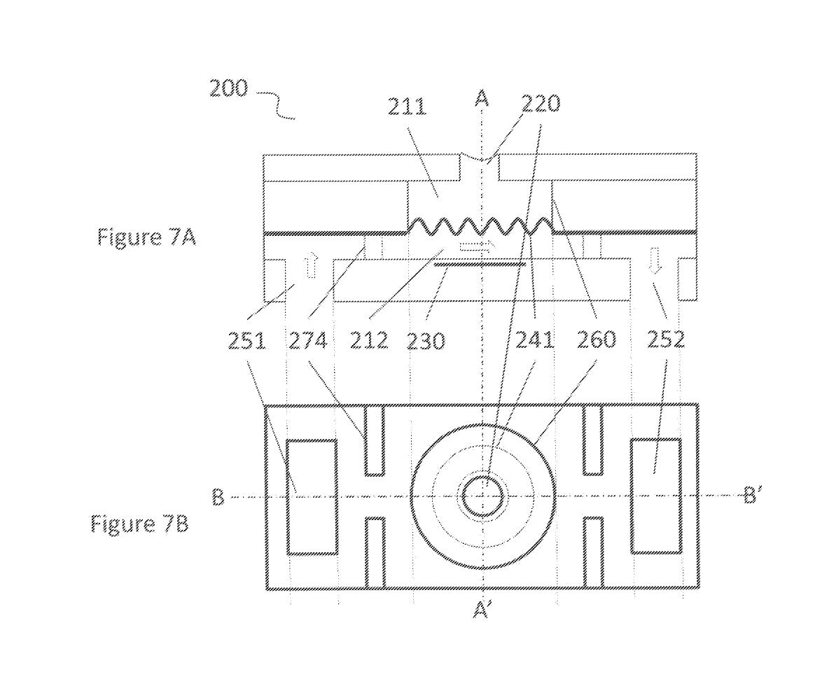

FIGS. 6A and 7A, and 6B and 7B show the same views as are shown in FIGS. SA and 5B, respectively. In FIGS. 6A and 6B, the fluidic impedance structure 270 of the liquid dispenser 200 includes a plurality of triangular posts 273. In FIGS. 7A and 7B, the fluidic impedance structure 270 of the liquid dispenser 200 includes a wall 274 that extends into the second liquid chamber 212 to impede the flow of liquid through second chamber 212.

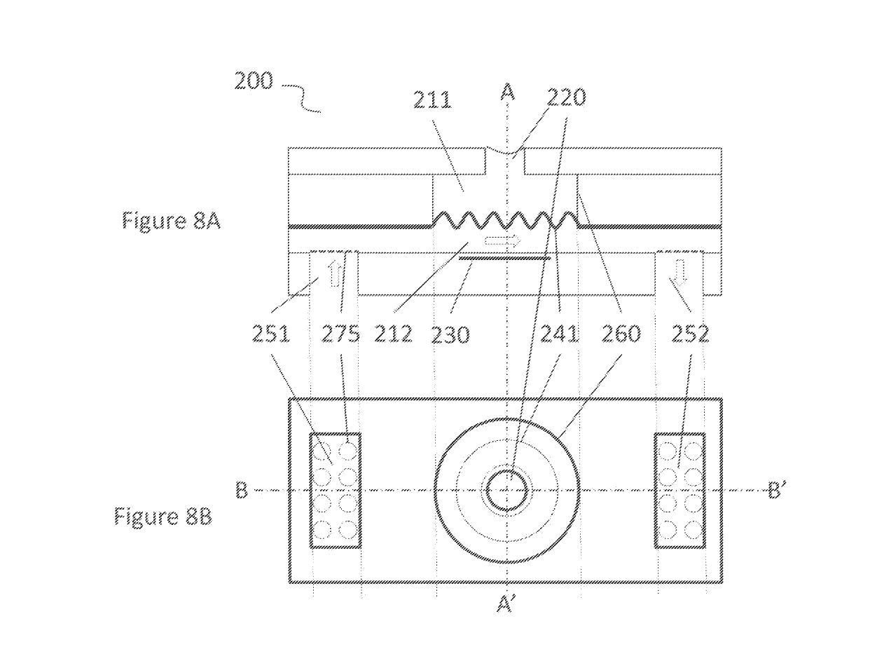

Referring to FIGS. 8A and 8B, a cross sectional view of liquid dispenser 200 and a plan view of flexible membrane 241 and second liquid chamber 212 are shown. The cross sectional view in FIG. 8A of liquid dispenser 200 is taken along line B-B′ shown in FIG. 8B that includes the center axis A-A′. The plan view in FIG. 8B includes the portion of flexible membrane 241 that separates and fluidically seals first liquid chamber 211 and second chamber 212, and second liquid chamber 212. Flexible membrane 241 is circular in shape. First liquid chamber 211 is circular in shape. The fluidic impedance structure 270 of the liquid dispenser 200 includes a porous member 275 positioned at the interface of the second liquid chamber and liquid return channel 252. In other example embodiment of the invention, a porous member 275 positioned at the interface of the second liquid chamber 212 and the liquid supply channel 251 can be included along with the one positioned at the interface of the second liquid chamber and liquid return channel 252.

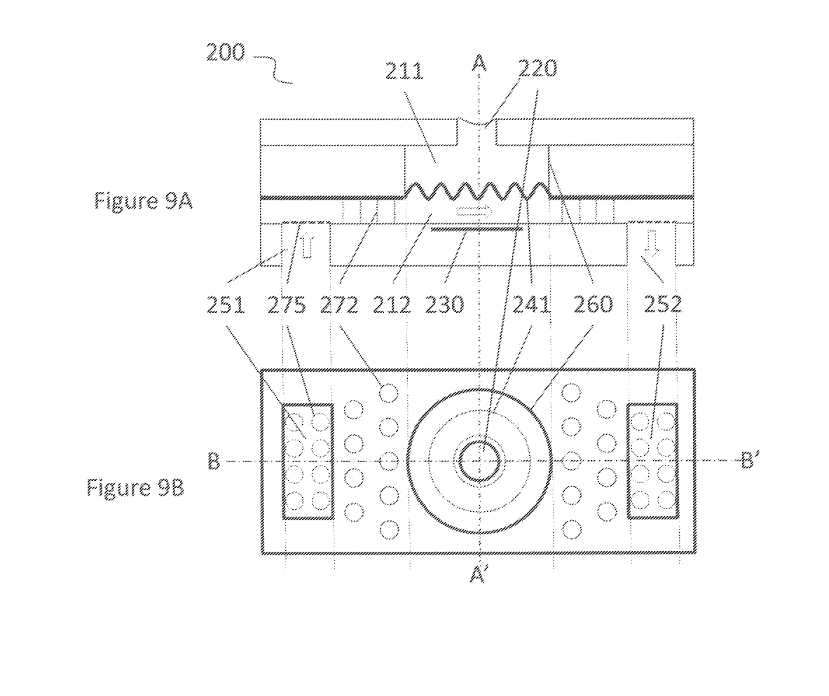

Referring to FIG. 9A and 9B, a cross sectional view of liquid dispenser 200 and a plan view of flexible membrane 241 and second liquid chamber 212 are shown. The cross sectional view in FIG. 8A of liquid dispenser 200 is taken along line B-B′ shown in FIG. 8B that includes the center axis A-A′. The plan view in FIG. 8B includes the portion of flexible membrane 241 that separates and fluidically seals first liquid chamber 211 and second chamber 212, and second liquid chamber 212. Flexible membrane 241 is circular in shape. The liquid dispenser 200 includes a first fluidic impedance structure that includes a post 272 positioned in the second liquid chamber 212 between the heater 230 and the liquid return channel 252. The liquid dispenser 200 also includes a second fluidic impedance structure that includes a porous member 275 positioned at the interface of the second liquid chamber 212 and the liquid return channel 252. Optionally, a porous member 275 positioned at the interface of the second liquid chamber 212 and the liquid supply channel 251 can be included along with the one positioned at the interface of the second liquid chamber and liquid return channel 252.

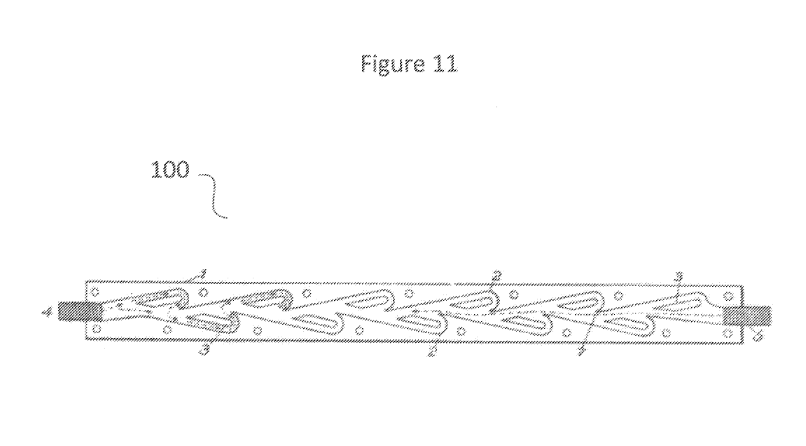

Other types of fluidic impedance structures, commonly referred to as fluidic diodes or no-moving part (NVP) fluidic resistance microvalves, also can be included in the present invention. Referring to FIG. 11, a Tesla fluid valve or fluid diode is included in fluidic impedance structure 100. The Tesla fluid diode itself is conventional with the specific configuration shown in FIG. 11 having been described in U.S. Pat. No. 1,329,559, issued to Tesla, on Feb. 3, 1920, the disclosure of which is incorporated by reference in its entirety herein. In another example embodiment, fluidic impedance structure 100 can be a MEMS diaphragm check valve, for example, the one described in Optimization of No-Moving Part Fluidic Resistance Microvalves with Low Reynolds Number, 2010 IEEE 23^{rd}, by Yongbo Deng; Zhenyu Liu; Ping Zhang; Yihui Wu; and Korvink, J. G., the disclosure of which is incorporated by reference in its entirety herein. The design of these devices is such that they allow for easy fluid flow in one direction while requiring greater fluid work when the flow direction changes. In other words, the diodicity of fluidic diode or a NMP microvalve is given as the ratio of the pressure drop that occurs across the valve when a constant flow is maintained in opposite directions through the fluid diode. One important observation is that regardless of the NMP microvalve design, at low Reynolds numbers, the diodicity is low, meaning that fluid flow is unimpeded in either direction. Accordingly, it is believed that the present invention unexpectedly provides a fluidic impedance structure that has little or no effect on the flow of the working fluid but has a strong effect in restricting the pressure build up that results from the actuation of the print head as described above.

It is believed that the liquid dispenser of the present invention causes more of the pressure, generated by the vapor bubble, to be directed toward the flexible membrane and ultimately to the ejected drop, without sacrificing fluid flow. As such, the performance of the liquid dispenser results in more rapid heater actuation at a reduced energy with reduced heat dissipation.

When compared to conventional thermal DOD devices, it is believed that the liquid dispenser of the present invention provides improved ink/substrate latitude since the image making ink is not heated prior to drop ejection. Inclusion of a potentially longer life, lower boiling point bubble-generating working fluid that is benign to the heater and helps to provide improved energy efficiency while reducing or even eliminating kogation. The flow restrictions of the present invention help to improve drop ejection efficiency by reducing fluid back-flow into the inlet and outlet channels of the working fluid chamber. In turn, this helps provide increased drop ejection frequency due at least in part to lower actuation energy and faster cooling of the heater. Alternatively, larger drops can be ejected more quickly using the same amount of actuation input energy.

When compared to conventional piezo DOD actuators, it is believed that the liquid dispenser of the present invention provides print heads that are smaller or have increased nozzle density. As the liquid dispenser of the present invention provides larger actuator displacement, its size is reduced, and can operate at higher frequencies.

The example embodiments described above can be implemented individually (by themselves) or in combination with each other to obtain the desired performance of the liquid dispenser of the present invention. The invention has been described in detail with particular reference to certain preferred embodiments thereof, but it will be understood that variations and modifications can be effected within the scope of the invention.

### PARTS LIST

100 a fluidic impedance structure
135 center point of a heater
160 a vapor bubble
170 a liquid drop
200 a liquid dispenser
211 a first liquid chamber
212 a second liquid chamber
220 a nozzle
230 a heater
230a,b two halves of a split heater
240 a flexible membrane
241 a corrugated flexible membrane
251 a liquid supply channel
252 a liquid return channel
270 a fluidic impedance structure
271 a second fluidic impedance structure.
272 a plurality of circular posts
273 a plurality of triangular posts
274 a wall
275 a porous member
I₁ lumped parameter inertance of the flexible membrane
I₂ lumped parameter inertance of the working fluid inlet and outlet channels
V₁ velocity and displacement of the load I₁
V₂ velocity and displacement of the load I₂

1. A liquid dispenser comprising:
a first liquid chamber including a nozzle;
a second liquid chamber;
a liquid supply channel in fluid communication with the second chamber;
a liquid return channel in fluid communication with the second chamber;
a heater associated with the second liquid chamber;
a flexible membrane positioned to separate and fluidically seal the first liquid chamber and the second liquid chamber;
a liquid supply that provides a liquid that flows continuously from the liquid supply through the liquid supply channel through the second liquid chamber through the liquid return channel and back to the liquid supply; and
a fluidic impedance structure positioned in the second liquid chamber between the heater and the liquid return channel.

2. The liquid dispenser of claim 1, wherein the fluidic impedance structure includes a fluid diode.

3. The liquid dispenser of claim 1, wherein the fluidic impedance structure includes a post.

4. The liquid dispenser of claim 1, wherein the fluidic impedance structure includes a wall that extends into the second liquid chamber.

5. The liquid dispenser of claim 1, wherein the fluidic impedance structure includes a porous member positioned at the interface of the second liquid chamber and the liquid return channel.

6. The liquid dispenser of claim 1, the fluidic impedance structure being a first fluidic impedance structure, the liquid dispenser further comprising:
a second fluidic impedance structure positioned in the second chamber between the heater and the liquid supply channel.

7. The liquid dispenser of claim 1, wherein the flexible membrane is corrugated.

8. The liquid dispenser of claim 7, the nozzle including a center point, the heater including a center point, and the flexible corrugated membrane including a center point, wherein the center points of the nozzle, the heater, and the flexible corrugated membrane are collinear relative to each other.

9. The liquid dispenser of claim 1, the first liquid chamber including a first liquid and the second liquid chamber including a second liquid, wherein the first liquid and the second liquid are different liquids.

10. The liquid of dispenser of claim 9, wherein the second liquid has a lower boiling point when compared to first liquid.

11. The liquid of dispenser of claim 9, wherein the second liquid is a non-corrosive liquid.

12. The liquid dispenser of claim 1, wherein the heater is a split heater.

13. The liquid dispenser of claim 1, the nozzle including a center point, the heater including a center point, and the flexible membrane including a center point, wherein the center points of the nozzle, the heater, and the flexible membrane are collinear relative to each other.
